(19) United States
(12) Patent Application Publication
(10) Pub. No.: US 2025/0235882 A1
(43) Pub. Date: Jul. 24, 2025

(54) NOZZLE FOR DISPENSER ASSEMBLY

(71) Applicant: Honda Motor Co., Ltd., Tokyo (JP)

(72) Inventors: Sam Williamson, Ottawa (CA); Jason Rogers, Plain City, OH (US)

(21) Appl. No.: 18/421,819

(22) Filed: Jan. 24, 2024

(51) Int. Cl. B05B 1/14

(52) U.S. Cl. CPC B05B 1/14

(57) ABSTRACT

A nozzle for a dispenser for dispensing a sealant includes a base structure adapted to be removably coupled to the dispenser and having a body having a first longitudinal end, a second longitudinal end, and an inner surface defining an elongated passage extending from the first longitudinal end to the second longitudinal end. The base structure includes at least two conduits extending outwardly from an outer surface of the body in a longitudinal direction. Each of the at least two conduits include an outlet defined at the inner surface of the body to enable an entry of compressed air inside the elongated passage. The nozzle includes a nozzle structure coupled to the body and extending outwardly in the longitudinal direction from the second longitudinal end of the body. The nozzle structure includes an edge defining an outlet opening to enable an exit of the sealant from the nozzle structure.

### BACKGROUND

The disclosed subject matter relates generally to a dispenser assembly suitable for dispensing a sealant. More particularly, the disclosed subject matter relates to a self-cleaning nozzle of a dispenser assembly.

Sealant dispensers are widely used in various industries, for example, manufacturing, construction, or automobile industries, to apply sealant on the components. However, when the dispenser is turned off, residual particles of sealant leave the dispenser at a slower speed, often referred to as spit. This spit may land on the part, for example, car body, on which the sealant is being applied, at undesirable places, which is undesirable.

### SUMMARY

In accordance with one embodiment of the present disclosure, a nozzle for a dispenser for dispensing a sealant is disclosed. The nozzle includes a base structure adapted to be removably coupled to the dispenser and having a body having a first longitudinal end, a second longitudinal end, and an inner surface defining an elongated passage extending from the first longitudinal end to the second longitudinal end. The base structure further includes at least two conduits extending outwardly from an outer surface of the body in a longitudinal direction. Each of the at least two conduits include an outlet defined at the inner surface of the body to enable an entry of compressed air inside the elongated passage. The nozzle further includes a nozzle structure coupled to the body and extending outwardly in the longitudinal direction from the second longitudinal end of the body. The nozzle structure includes an edge defining an outlet opening to enable an exit of the sealant from the nozzle structure.

In accordance with another embodiment of the present disclosure, a dispenser assembly for dispensing a sealant is provided. The dispenser assembly includes a dispenser and a nozzle including a base structure removably coupled to the dispenser and having a body having a first longitudinal end, a second longitudinal end, and an inner surface defining an elongated passage extending from the first longitudinal end to the second longitudinal end. The base structure further includes at least two conduits extending outwardly from an outer surface of the body in a longitudinal direction. Each of the at least two conduits include an outlet defined at the inner surface of the body to enable an entry of compressed air inside the elongated passage. The nozzle further includes a nozzle structure coupled to the body and extending outwardly in the longitudinal direction from the second longitudinal end of the body and away from the dispenser. The nozzle structure includes an edge defining an outlet opening to enable an exit of the sealant from the nozzle.

In accordance with yet a further embodiment of the present disclosure a nozzle for a dispenser for dispensing sealant is disclosed. The nozzle includes a base structure adapted to be removably coupled to the dispenser and having a body having a first longitudinal end, a second longitudinal end, and an inner surface defining an elongated passage extending from the first longitudinal end to the second longitudinal end. The base structure further includes at least two conduits extending outwardly from an outer surface of the body in a longitudinal direction. Each of the at least two conduits include an outlet defined at the inner surface of the body to enable an entry of compressed air inside the elongated passage. The nozzle further includes a nozzle structure removably coupled to the body and extending outwardly in the longitudinal direction from the second longitudinal end of the body. The nozzle structure includes an edge defining an outlet opening to enable an exit of the sealant from the nozzle structure. The edge is sharp edge.

### BRIEF DESCRIPTION OF THE DRAWINGS

Certain embodiments of the present disclosure will be better understood from the following description taken in conjunction with the accompanying drawings in which:

FIG. 1 is a perspective view of a dispenser assembly having a dispenser and a nozzle attached to the dispenser, in accordance with one embodiment of the present disclosure;

FIG. 2 is a perspective view of the nozzle of FIG. 1 having a base structure and a nozzle structure coupled to the base structure, in accordance with one embodiment of the present disclosure;

FIG. 3 is a sectional view of the nozzle of FIG. 2, in accordance with one embodiment of the present disclosure; and

FIG. 4 depicts an exploded view of the nozzle of FIG. 2 depicting a portion of the base structure and the nozzle structure disengaged from the base structure, in accordance with one embodiment of the present disclosure.

### DETAILED DESCRIPTION OF EXEMPLARY EMBODIMENTS

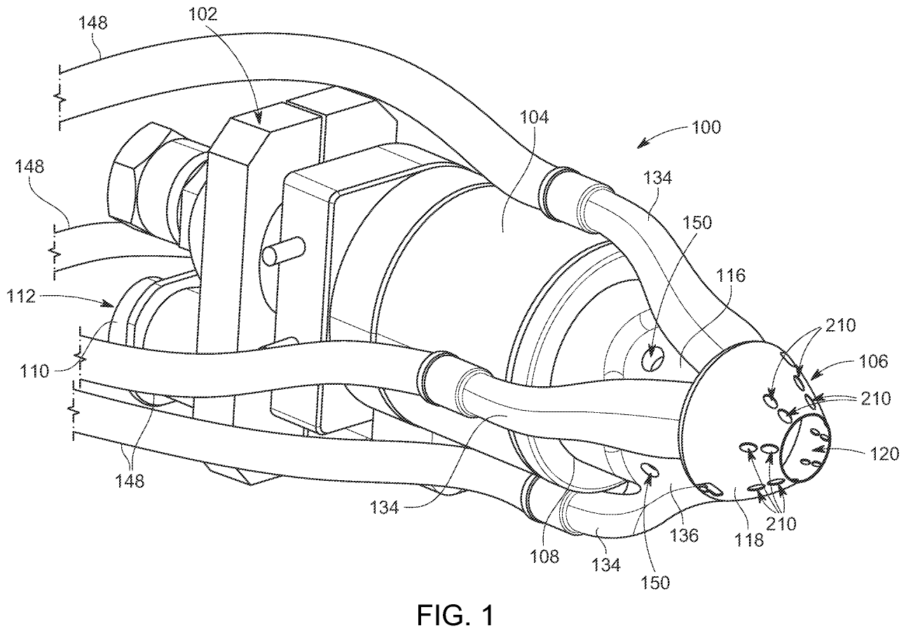

A few inventive aspects of the disclosed embodiments are explained in detail below with reference to the various figures. Exemplary embodiments are described to illustrate the disclosed subject matter, not to limit its scope, which is defined by the claims. Those of ordinary skill in the art will recognize a number of equivalent variations of the various features provided in the description that follows. Embodiments are hereinafter described in detail in connection with the views and examples of FIGS. 1-4, wherein like numbers indicate the same or corresponding elements throughout the views.

FIG. 1 illustrates a perspective view of a dispenser assembly 100 for dispensing a sealant, for example, an adhesive, in accordance with one embodiment of the present disclosure. As shown, the dispenser assembly 100 includes a dispenser 102 including an applicator 104, for example, a gun, and a nozzle 106 removably coupled to the applicator 104. The applicator 104 includes a first end 108 defining an outlet (not shown) through which the sealant exits the dispenser 102, and a second end 110 defining an inlet 112 for receiving the sealant from a storage unit (not shown). The dispenser 102 may include a valve (not shown) arranged at the second end 110 of the applicator 104 to control a flow of the sealant from the storage unit to the applicator 104. Moreover, in an embodiment, the applicator 104 may be an electrically operated applicator having a motor assembly to control an outlet of the sealant from the applicator 104 to the nozzle 106.

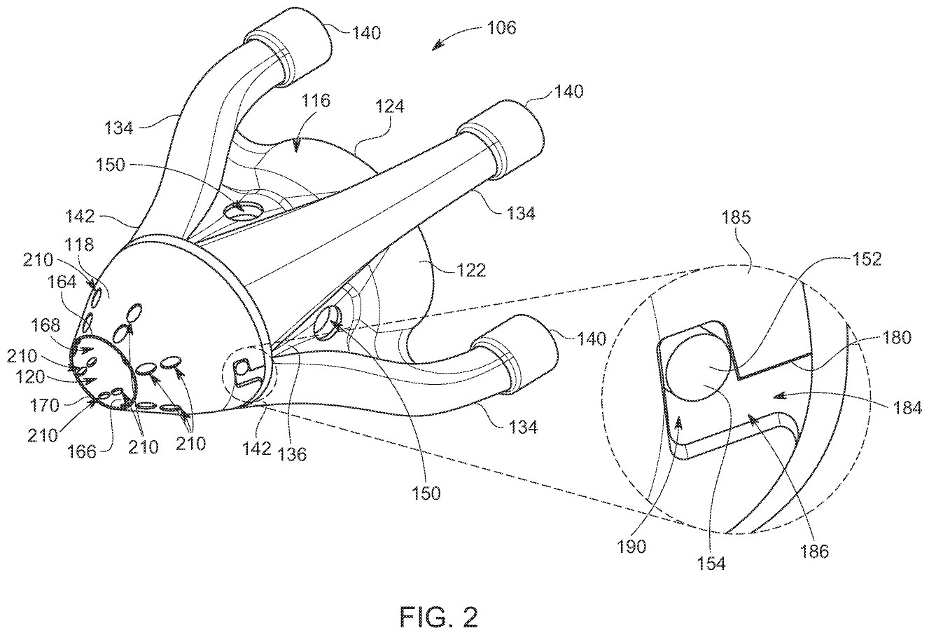

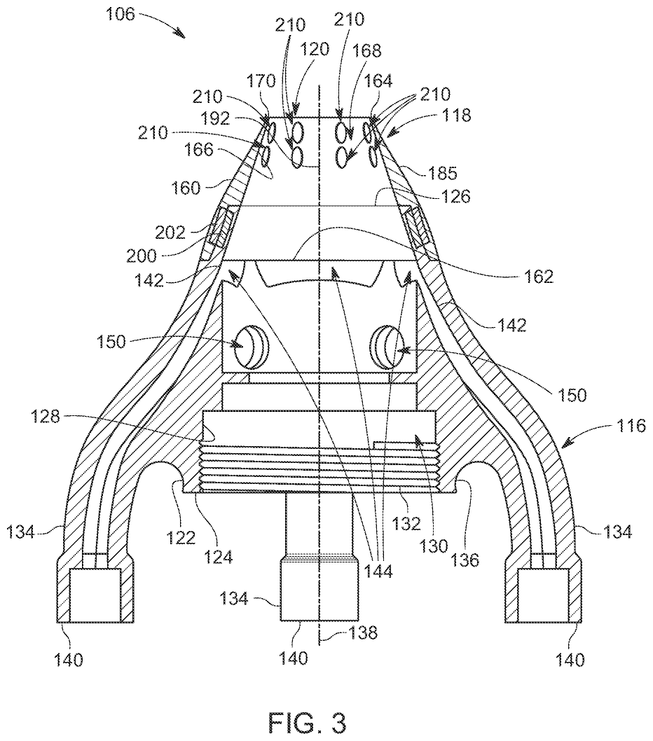

The nozzle 106 enables an application of the sealant on a component and provides a desired control over one or more characteristics of the flow of the sealant being applied to the component as well as reduces accumulation of the sealant inside the nozzle 106 and along an outlet opening 120 of the nozzle 106. As shown in FIGS. 2 and 3, the nozzle 106 includes a base structure 116 adapted to be removably coupled to the applicator 104 (i.e., dispenser 102) and a nozzle structure 118 adapted to be removably coupled to the base structure 116 of the nozzle 106. The base structure 116 includes a substantially hollow body 122 having a first longitudinal end 124, a second longitudinal end 126 disposed opposite to the first longitudinal end 124, and an inner surface 128 defining an elongated passage 130 extending from the first longitudinal end 124 to the second longitudinal end 126. To facilitate the engagement of the base structure 116 with the dispenser 102 (i.e., the applicator 104), the inner surface 128 defines a threaded structure 132 disposed at the first longitudinal end 124 of the body 122. The body 122 may include a cylindrical shape or a frustoconical shape.

Further, the base structure 116 includes at least two conduits, for example, four conduits 134, connected to the body 122 and extending outwardly from an outer surface 136 of the body 122 in a longitudinal direction. The conduits 134 extend in a direction substantially parallel to a central axis 138 of the body 122, and are arrayed around an outer circumference of the body 122. Moreover, each of the conduits 134 includes an inlet end 140, i.e., free end 140, arranged rearwardly of the first longitudinal end 124 of the body 122 and an outlet end 142 connected to the body 122, defining an outlet 144 of the associated conduit 134 at the inner surface 128 of the body 122. The conduits 134 are arranged to enable flow of compressed air inside the elongated passage 130 of the base structure 116. Further, the outlets 144 of the conduits 134 are oriented to allow a suitable flow of the compressed air inside the elongated passage 130 and exit of the compressed air through the outlet opening 120 of the nozzle 106 (i.e., nozzle structure 118) to enable a removal of the sealant deposited inside the nozzle 106. To enable a supply of compressed air inside the conduits 134, suitable supply hoses 148 are connected to the inlet ends 140 of the conduits 134. To ensure and enhance the uniform flow of compressed air through the nozzle 106, the base structure 116 may also include a plurality of holes 150 extending from the inner surface 128 to the outer surface 136 of the body 122 and arrayed circularly around the central axis 138 of the body 122. As shown in FIG. 3, the holes 150 are disposed at a location distally to the second longitudinal end 126 relative to the outlets 144 of the conduits 134. Accordingly, the outlets 144 of the conduits 134 are arranged between the second longitudinal end 126 of the body 122 and the holes 150.

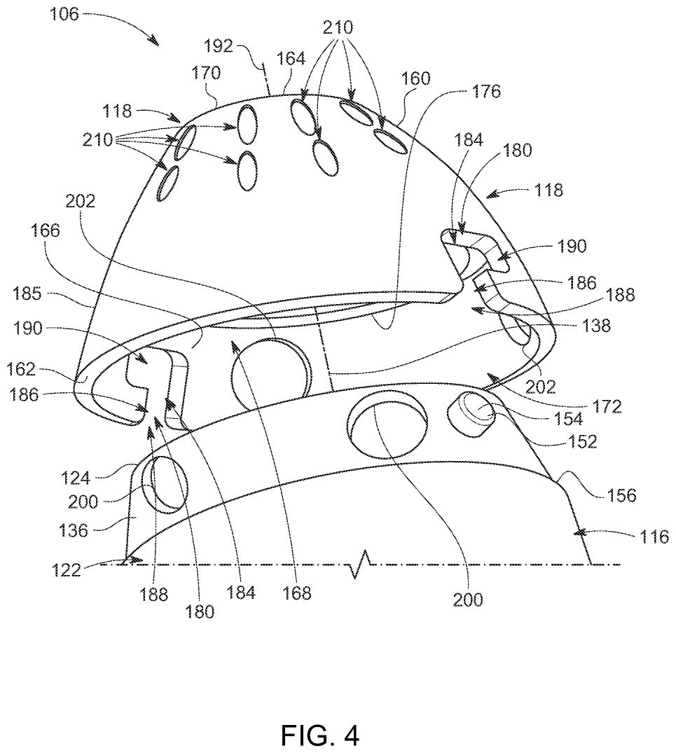

Further, to facilitate the removable engagement/coupling of the base structure 116 with the nozzle structure 118, the base structure 116 includes at least one engagement structure 152, four example, two engagement structures 152, arranged proximate to the second longitudinal end 126 of the body 122, and arrayed around the outer circumference of the body 122. As shown in FIGS. 2 and 4, each of the engagement structures 152 is a tab 154 extending radially outwardly from the outer surface 136 of the body 122. Further, to enable the proper engagement of the base structure 116 and the nozzle structure 118, the outer surface 136 of the body 122 defines a seat 156, i.e., step 156, on which an end of the nozzle structure 118 rests, disposed proximate to the second longitudinal end 126. In an assembly of the base structure 116 with the nozzle structure 118, a portion of the body 122 extending between the second longitudinal end 126 and the seat 156 is arranged inside the nozzle structure 118. It may be appreciated that engagement structures 152 are located between the seat 156 and the second longitudinal end 126.

As shown in FIGS. 3 and 4, the nozzle structure 118 includes a hollow frustoconical body structure 160 having a first axial end 162, and a second axial end 164 disposed opposite to the first axial end 162. Further, an inner surface 166 of the body structure 160 i.e., nozzle structure 118 defines an elongated channel 168 extending from the first axial end 162 to the second axial end 164, with the outlet opening 120 of the elongated channel 168 (i.e., nozzle 106) arranged at the second axial end 164 defined by a substantially circular edge 170 of the body structure 160. The edge 170 is a sharp edge that restricts the accumulation of the sealant at the second axial end 164 of the body structure 160, and therefore prevents clogging of the outlet opening 120 of the nozzle structure 118.

Further, the first axial end 162 of the body structure 160 defines an opening 172 to enable the partial insertion of the base structure 116 inside the nozzle structure 118 for coupling/engaging the nozzle structure 118 and the base structure 116. As best shown in FIG. 4, the inner surface 166 of the nozzle structure 118 also defines a step 176 extending along an inner circumference of the body structure 160. In an assembly of the nozzle structure 118 and the base structure 116, the second longitudinal end 126 of the body 122 of the base structure 116 abuts the step 176 of the nozzle structure 118, while the first axial end 162 of the body structure 160 of the nozzle structure 118 abuts the seat 156 of the body 122 of the base structure 116. It may be appreciated that thickness of the base structure 116 at the second longitudinal end 126 is identical to a width of the step 176 to provide a smooth transition between the base structure 116 and the nozzle structure 118 along the respective inner surfaces 128, 166.

To facilitate the removable coupling of the nozzle structure 118 with the base structure 116, the nozzle structure 118 includes at least one retention structure 180, for example, two retention structures 180, arrayed along the circumference of the body structure 160. The retention structures 180 engage with the engagement structures 152 of the base structure 116, and are disposed between the first axial end 162 and the step 176 of the nozzle structure 118. In the illustrated embodiment, each of the retention structures 180 includes a groove 184 extending from an outer surface 185 of the body structure 160 of the nozzle structure 118 to the inner surface 166 of the nozzle structure 118. As shown in FIGS. 2 and 4, each of the groove 184 includes a first groove portion 186 extending in a longitudinal direction from the first axial end 162 of the nozzle structure 118 defining an opening 188 of the groove 184 at the first axial end 162 and a second groove portion 190 extending arcuately around a central axis 192 of the body structure 160 from the first groove portion 186. The opening 188 of the first groove portion 186 is configured to facilitate an insertion of a single tab 154 inside the associated groove 184 and the second groove portion 190 retains the associated tab 154 inside the groove 184 to enable retention of the tab 154 inside the groove 184, thereby securely connecting the base structure 116 with the nozzle structure 118.

Accordingly, to engage the base structure 116 with the nozzle structure 118, the openings 188 of the first groove portions 186 are aligned with the tabs 154. Thereafter, the base structure 116 is pushed inside the nozzle structure 118 such that the first axial end 162 of the body structure 160 abuts the seat 156 of the base structure 116 and second longitudinal end 126 of the body 122 abuts the step 176, causing the insertion of the tabs 154 inside the associated first groove portions 186 through the respective openings 188. Subsequently, the nozzle structure 118 is rotated relative to the base structure 116 about the central axis 192, thereby moving the tabs 154 inside the respective second groove portions 190. In this manner, the nozzle structure 118 and the base structure 116 are secured with each other. Although the removably engagement of the nozzle structure 118 with the base structure 116 is shown and contemplated, it may be appreciated that nozzle structure 118 may be integrally formed with the base structure 116. In such a case, the engagement structures 152, the retention structures 180, the step 176, and the seat 156 may be omitted.

Additionally, or optionally, referring to FIG. 4, to achieve a firm engagement of the nozzle structure 118 with the base structure 116, the base structure 116 may include a plurality of first magnets 200 coupled to the body 122 and arrayed circularly along the outer circumference of the body 122. As shown in FIG. 4, the first magnets 200 are arranged between the second longitudinal end 126 and the seat 156 of the base structure 116. To magnetically couple the nozzle structure 118 and the base structure 116, the nozzle structure 118 may include a plurality of second magnets 202 arranged proximate to the first axial end 162 of the body structure 160 of the nozzle structure 118 and between the first axial end 162 and the step 176 of the nozzle structure 118. The plurality of second magnets 202 is arrayed circularly around the central axis 192 of the nozzle structure 118 and magnetically coupled with the plurality of the first magnets 200.

Moreover, the nozzle structure 118 defines a plurality of holes 210 extending through the body structure 160 and extending from the inner surface 166 to the outer surface 185. As shown, the plurality of holes 210 is arranged proximate to the second axial end 164, and are arrayed circularly around a central axis 192 of the body structure 166 (i.e., the nozzle structure 118). Referring to FIG. 4, the plurality of holes 210 is arranged between the second axial end 164 of the body structure 160 and the step 176 of the nozzle structure 120. Moreover, in the illustrated embodiment, the holes 210 are arranged in two rows, however, it may be envisioned that the plurality of holes may be arranged in a single row or more than two rows. The holes 210 facilitate an exit of the compressed air from the nozzle structure 118 to enable a cleaning or removal of the spit i.e., sealant accumulated on the outer surface 185, around the opening 120. The holes 210 allow air to flow from the inside to the outside at a shallow angle to direct the airflow along the outer surface 185 to facilitate the cleaning of the outer surface 185.

The foregoing description of embodiments and examples has been presented for purposes of illustration and description. It is not intended to be exhaustive or to limit the invention to the forms described. Numerous modifications are possible in light of the above teachings. Some of those modifications have been discussed and others will be understood by those skilled in the art. The embodiments were chosen and described in order to best illustrate certain principles and various embodiments as are suited to the particular use contemplated. The scope of the invention is, of course, not limited to the examples or embodiments set forth herein, but can be employed in any number of applications and equivalent devices by those of ordinary skill in the art. Rather it is hereby intended the scope of the invention be defined by the claims appended hereto.

What is claimed is:

1. A nozzle for a dispenser for dispensing a sealant, the nozzle comprising:
a base structure adapted to be removably coupled to the dispenser and having
a body having a first longitudinal end, a second longitudinal end, and an inner surface defining an elongated passage extending from the first longitudinal end to the second longitudinal end,
at least two conduits extending outwardly from an outer surface of the body in a longitudinal direction, wherein each of the at least two conduits include an outlet defined at the inner surface of the body to enable an entry of compressed air inside the elongated passage; and
a nozzle structure coupled to the body and extending outwardly in the longitudinal direction from the second longitudinal end of the body, the nozzle structure includes an edge defining an outlet opening to enable an exit of the sealant from the nozzle structure.

2. The nozzle of claim 1, wherein the nozzle structure is removably coupled to the base structure.

3. The nozzle of claim 2, wherein
the base structure includes at least one engagement structure disposed proximate to the second longitudinal end of the body, and
the nozzle structure includes at least one retention structure arranged at a first end of the nozzle structure and configured to engage with the at least one engagement structure to enable the removable coupling of the nozzle structure with the base structure.

4. The nozzle of claim 3, wherein
the at least one engagement structure includes at least one tab extending radially outwardly from the outer surface of the body of the base structure, and
the at least one retention structure includes at least one groove configured to receive the at least one tab.

5. The nozzle of claim 4, wherein the at least one groove includes
a first groove portion extending in a longitudinal direction from the first end defining an opening of the groove at the first end to facilitate an insertion of the tab inside the groove, and
a second portion extending arcuately around a central axis of the nozzle structure from the first groove portion.

6. The nozzle of claim 1, wherein
the base structure includes a plurality of first magnets arrayed circularly around a circumference of the body and coupled to the body, and
the nozzle structure includes a plurality of second magnets arranged proximate to the first end and arrayed circularly around a central axis of the nozzle structure and configured to magnetically couple with the plurality of first magnets.

7. The nozzle of claim 1, wherein the inner surface of the body defines a threaded structure disposed proximate to the first longitudinal end of the body to facilitate a threaded engagement of the base structure with the dispenser.

8. The nozzle of claim 1, wherein the body defines a plurality of holes extending from the inner surface of the body to the outer surface of the body and arrayed circularly around a central axis of the body.

9. A dispenser assembly for dispensing a sealant, comprising:
a dispenser; and
a nozzle including
a base structure removably coupled to the dispenser and having a body having a first longitudinal end, a second longitudinal end,
and an inner surface defining an elongated passage extending from the first longitudinal end to the second longitudinal end, and
at least two conduits extending outwardly from an outer surface of the body in a longitudinal direction, wherein each of the at least two conduits include an outlet defined at the inner surface of the body to enable an entry of compressed air inside the elongated passage, and
a nozzle structure coupled to the body and extending outwardly in the longitudinal direction from the second longitudinal end of the body and away from the dispenser, the nozzle structure includes an edge defining an outlet opening to enable an exit of the sealant from the nozzle.

10. The dispenser assembly of claim 9, wherein the nozzle structure is removably coupled to the base structure.

11. The dispenser assembly of claim 10, wherein
the base structure includes at least one engagement structure disposed proximate to the second longitudinal end of the body, and
the nozzle structure includes at least one retention structure arranged at a first end of the nozzle structure and configured to engage with the at least one engagement structure to enable the removable coupling of the nozzle structure with the base structure.

12. The dispenser assembly of claim 11, wherein
the at least one engagement structure includes at least one tab extending radially outwardly from the outer surface of the body of the base structure, and
the at least one retention structure includes at least one groove configured to receive the at least one tab.

13. The dispenser assembly of claim 12, wherein the at least one groove includes
a first groove portion extending in a longitudinal direction from the first end defining an opening of the groove at the first end to facilitate an insertion of the tab inside the groove, and
a second portion extending arcuately around a central axis of the nozzle structure from the first groove portion.

14. The dispenser assembly of claim 9, wherein
the base structure includes a plurality of first magnets arrayed circularly around a circumference of the body and coupled to the body, and
the nozzle structure includes a plurality of second magnets arranged proximate to the first end and arrayed circularly around a central axis of the nozzle structure and configured to magnetically couple with the plurality of first magnets.

15. The dispenser assembly of claim 9, wherein the inner surface of the body defines a threaded structure disposed proximate to the first longitudinal end of the body to facilitate a threaded engagement of the base structure with the dispenser.

16. The dispenser assembly of claim 9, wherein the body defines a plurality of holes extending from the inner surface of the body to the outer surface of the body and arrayed circularly around a central axis of the body.

17. A nozzle for a dispenser for dispensing a sealant, the nozzle comprising:
a base structure adapted to be removably coupled to the dispenser and having
a body having a first longitudinal end, a second longitudinal end, and an inner surface defining an elongated passage extending from the first longitudinal end to the second longitudinal end,
at least two conduits extending outwardly from an outer surface of the body in a longitudinal direction, wherein each of the at least two conduits include an outlet defined at the inner surface of the body to enable an entry of compressed air inside the elongated passage; and
a nozzle structure removably coupled to the body and extending outwardly in the longitudinal direction from the second longitudinal end of the body, the nozzle structure includes an edge defining an outlet opening to enable an exit of the sealant from the nozzle structure, wherein the edge is sharp edge.

18. The nozzle of claim 17, wherein
the base structure includes at least one tab disposed proximate to the second longitudinal end of the body and extending radially outwardly from the outer surface of the body of the base structure, and
the nozzle structure includes at least one groove defined at a first end of the nozzle structure and configured to receive the at least one tab to enable the removable coupling of the nozzle structure with the base structure.

19. The nozzle of claim 18, wherein the at least one groove includes
a first groove portion extending in a longitudinal direction from the first end defining an opening of the groove at the first end to facilitate an insertion of the tab inside the groove, and
a second portion extending arcuately around a central axis of the nozzle structure from the first groove portion.

20. The nozzle of claim 17, wherein
the base structure includes a plurality of first magnets arrayed circularly around a circumference of the body and coupled to the body, and
the nozzle structure includes a plurality of second magnets arranged proximate to the first end and arrayed circularly around a central axis of the nozzle structure and configured to magnetically couple with the plurality of first magnets.
